(19) United States
(12) Patent Application Publication
(10) Pub. No.: US 2007/0109328 A1
(43) Pub. Date: May 17, 2007

(54) LED BRIGHTNESS CONTROL

(75) Inventor: Roger Lewis, Kansas City, MO (US)

Correspondence Address: Eric G. Halsne;Honeywell International Inc., P.O. Box 2245, 101 Columbia Road, Morristown, NJ, 07962, US

(73) Assignee: Honeywell International Inc.

(21) Appl. No.: 11/621,467

(22) Filed: Jan. 9, 2007

Related U.S. Application Data
(63) Continuation of application No. 09/834,276, filed on Apr. 12, 2001, now Pat. No. 7,176,948.
(60) Provisional application No. 60/196,770, filed on Apr. 12, 2000.

(51) Int. Cl. G09G 5/10

(52) U.S. Cl. 345/691

(57) ABSTRACT

A device for controlling the brightness of a one or more LEDs (light emitting diodes) includes a modulator having at least 11 bits of pulse width modulation resolution. A buffer receives pulses from the modulator. A driver may be coupled to receive pulses from the buffer and drive the one or more LEDs. A currently limiter may be employed to prevent damage to the one or more LEDs. An update rate may be selected to limit perceptible flicker of the one or more LEDs.

### CROSS-REFERENCES TO RELATED APPLICATIONS

This application is a continuation of U.S. patent application Ser. No. 09/834,276, filed Apr. 12, 2001, which claims priority from co-pending U.S. application Ser. No. 60/196,770 entitled: “Apparatus and Method of Extending Pulse Width Modulation Resolution,” filed Apr. 12, 2000, the entire text of which is incorporated by reference.

### BACKGROUND

The present invention relates generally to control of light emitting diode (LED) devices and in particular to control of LED backlights using pulse width modulation. The present invention also relates to controllers for LED devices and more particularly to dimming controllers for displays backlit by LED displays.

A light emitting diode, or LED, comprises a diode that emits visible light when current passes through it. LEDs have several applications. Certain display devices, for example, but not limited to, aircraft cockpit displays, use an array of LEDs to backlight and illuminate a liquid crystal display (LCD). Controlling the amount of light emitted by the LED array is desirable to adjust the brightness of the display. The brightness level impacts the ease with which the display may be viewed under certain lighting conditions, such as bright sunlight or dark environment; and individual viewer comfort level with the display.

In some applications, the brightness level is more than a convenience factor. For example, in the aviation environment, if the display is illuminated too brightly at night, the excessive brightness may adversely impact the pilot's night vision. Impaired night vision adversely impacts the safety of flight.

The brightness level additionally impacts the amount of power required to operate the device as well as the heat given off by the display. Power consumption affects the length of time the device can operate on battery power and the electrical load placed on the vehicle power supply systems. The heat given off by the display also affects what, if any, cooling of the display and surrounding equipment is required. Cooling devices add cost and complexity to equipment and systems. In aircraft/spacecraft applications, cooling systems add unwanted additional weight to the vehicle. Furthermore, if the display generates too much heat, touching or otherwise operating the display may cause discomfort to the user.

The amount of light emitted by the diode can be controlled by controlling the amount of power supplied to the diode where power equals voltage times current (P=V*I). In certain prior art devices, a microprocessor device is coupled to drive circuitry that controls the LED display brightness. In such designs, a technique known as pulse width modulation (PWM) is used to control the power supplied to the device. Under control of the microprocessor, the drive circuitry supplies current to the LED for a predetermined amount of time, or one pulse width. In this manner, by varying the number of pulses received and the width of the pulses, the total power supplied to the LED, and hence the brightness can be controlled.

One significant limitation on this prior art design is that the pulse frequency and duration are limited by the resolution with which the pulse frequency and width can be defined by the microprocessor. For this reason, it is not always possible to control the LED display with the specificity and precision desired. This fact may result in the LED display being too bright at one setting, but too dark at the next available setting. In an aviation environment, this fact can cause the cockpit display to be illuminated too brightly at night even on the lowest available setting.

Correction of the above deficiencies cannot presently be accomplished without a complete redesign of the microprocessor/driver hardware. Redesign is frequently impractical because often, the pulse width modulation output of the microprocessor is part of a predefined set of operations purchased with the selected microprocessor chip; and its resolution is limited by the number of bits the microprocessor can output. Redesign of standard LED drive circuit hardware is also undesirable due to the cost of custom designing and fabricating such circuits.

Thus, in theory, the lowest luminance level which can be achieved by the display is limited only by the resolution with which the pulse frequency and width can be conveyed from the modulator to the LED circuit. In practice, however, these low brightness levels can be difficult to achieve. The LED devices which comprise the display experience performance changes as a function of temperature. In addition, the LED devices may not have uniform electrical properties. These nonuniformities result in different power levels required to operate individual ones of the LED devices. Precise control of the array brightness in prior art designs is therefore difficult especially at low brightness levels. Furthermore, the human eye is especially adept at perceiving light emitted from the diode even at low power levels. This fact further exacerbates the nonlinearities in luminescence present in prior art devices. Thus, it is not presently possible to control the brightness of the LED display with the precision desired.

### BRIEF DESCRIPTION OF THE DRAWINGS

FIG. 1A is a diagram of a ¼ duty cycle pulse width modulation scheme using a two bit resolution pulse width modulator;

FIG. 1B is a diagram of a ½ duty cycle pulse width modulation scheme using a two bit resolution pulse width modulator;

FIG. 1C is a diagram of a ¾ duty cycle pulse width modulation scheme using a two bit resolution pulse width modulator;

FIG. 2 is a truth table for improved resolution pulse width modulation using a two bit modulator with additional timer state according to an embodiment of the present invention;

FIG. 3A is a diagram of a pulse width modulation scheme having improved resolution according to an embodiment of the present invention;

FIG. 3B is a diagram of a second pulse width modulation scheme having improved resolution according to an embodiment of the present invention;

FIG. 4 is a truth table of modulator output with overflow bit vs. timer state for desired duty cycle according to an embodiment of the present invention;

FIG. 5A is a diagram of a five bit virtual pulse width modulation scheme having an update rate of 125 Hz according to an embodiment of the present invention;

FIG. 5B is a diagram of a six bit virtual pulse width modulation scheme having an update rate of 62.5 Hz according to an embodiment of the present invention;

FIG. 6 is a diagram of a pulse width modulation scheme incorporating an additional timer having a duration which is an integer multiple of the pulse width modulator output according to an embodiment of the present invention;

FIG. 7 is a diagram of a pulse width modulation scheme incorporating an additional timer having a duration larger than and not an integer multiple of the period of the pulse width modulator output according to an embodiment of the present invention resulting in error of the expected PWM output;

FIG. 8 is a flow chart of a method useful for implementing the present invention;

FIG. 9 illustrates the output according to the flow chart of FIG. 8 for a virtual 11 bit modulator using an 8 bit modulator and 8 timer states; and

FIG. 10 is a block diagram of a pulse width modulation apparatus useful for controlling the brightness of a backlit display according to an embodiment of the present invention.

FIG. 11 is a circuit diagram of a controller according to an embodiment of the present invention.

FIG. 12 is a circuit diagram of an LED array according to an embodiment of the present invention.

### DETAILED DESCRIPTION

In various embodiment, a controller, or control circuit, controls LED display brightness. The control circuit includes a control signal buffer and an array driver that operate to control LED current in a manner linearly proportional to the level commanded by the control pulse. When pulse width modulation is used to control display brightness, the control circuit operates to respond by switching the current drawn through the LED array within the time frame of the shortest duration pulse. Precise control of display brightness is achieved at even the lowest of commanded brightness levels.

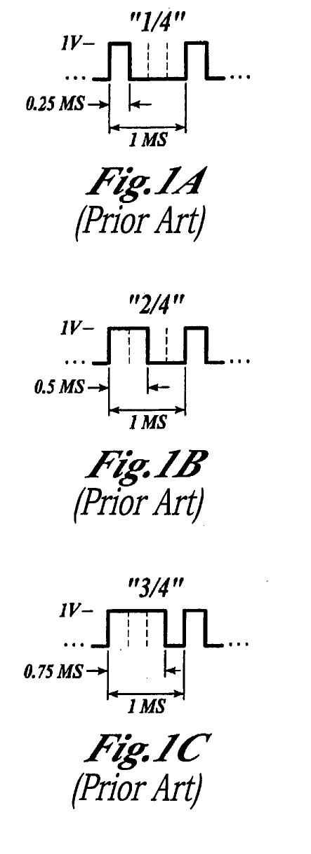

FIGs. 1A-1C contain illustrations of how pulse width modulation can be used to control power to a load such as, for example, an LED or array of LEDs. The PWM duty cycle is the ratio of the amount of time the pulse is on, to the interval of time in which the pulse is off. In the example of FIG. 1A, a pulse 2 is on during the interval from t=0 seconds to t=0.25 milliseconds (ms). No pulse occurs for the interval from t=0.25 ms to t=1 ms for a total of 0.75 ms. The duty cycle in the example of FIG. 1A is therefore ¼. The duty cycle in the example of FIG. 1B is ½, and the duty cycle of FIG. 1C is ¾.

If the magnitude of the pulse of FIGs. 1A-1C is 1 Volt, then the average voltage supplied to the LED in a 1 ms interval is 0.25V for FIG. 1A, 0.5V for FIG. 1B, and 0.75V in FIG. 1C. Thus, through operation of the pulse width modulation schemes of FIGs. 1A-1C, the total power supplied to the LED, and hence its brightness and thermal output can be controlled.

However, the power output mandated by the pulse width modulation scheme is limited by the resolution of the pulse width modulator. For example, if a pulse width modulator has n bits of resolution, the pulse width modulator can vary its output from 0 to 2n−1; and change its duty cycle in 1/(2″) step intervals. In the example of FIGS. 1A-1C, a pulse width modulator having a resolution of two bits was used to create the duty cycles and power outputs shown. The two bit pulse width modulator of FIGS. 1A-1C therefore has the following possible binary outputs: 00, 01, 10, and 11. Since there are four possible output values, the pulse width modulator can only change its duty cycle in intervals of 1/(2²) or ¼. Hence, the average power supplied can only be varied in ¼ V increments. Table I contains a truth table showing the output pulse as a function of modulator output for the two bit modulator used as an example throughout this document.

TABLE I
Duty Cycle For An Example Modulator Having Two Bits of Resolution
PWM Period = 1 ms

| Modulator | Output Pulse | |
|---|---|---|
| Binary Output | Duration (ms) | Duty Cycle |
| 00 | 0 | 0 |
| 01 | 0.25 | ¼ |
| 10 | 0.50 | ½ |
| 11 | 0.75 | ¾ |

Increasing the bit resolution of the pulse width modulator provides greater resolution in the duty cycle that can be specified. For example, the Motorola 68HC16Z1 is a common processor used to provide pulse width modulation outputs. This Motorola processor has a resolution of n=8 bits and can thus vary its output to have values corresponding to between 0 and 255. This processor can therefore increment the PWM duty cycle in steps 1/256.

Yet, even with an 8 bit processor, the resolution provided by the pulse width modulation scheme may not be adequate for the task at hand. Suppose, for purposes of illustration, that using the two bit pulse width modulator of FIGS. 1A-1C, an increment of ⅛ V was desired. This increment is not possible using the pulse width modulator of FIGS. 1A-1C, because the smallest increment that can be specified is ¼ V. Likewise, a duty cycle smaller than 1/256 cannot be specified using the 8 bit Motorola processor described above. Absent the present invention, the only way to achieve the desired resolution is to change the pulse width modulator to one having three bit or higher resolution. Changing the hardware in such fashion may be impractical because the desired hardware is unavailable or costly due to the associated hardware and software changes.

The present invention provides a method and computer program product for virtually increasing the resolution of a pulse width modulator having n bits. In one embodiment of the invention, the invention includes an additional timer with a predetermined associated number of states. During each of the timer states, the pulse width modulator output has one of 2ⁿ possible values. Thus, according to the present invention, a number of virtual bits, m, equal to the base 2 log of the number of timer states, can be added to the n existing bits of resolution. The resulting pulse width modulation has n+m bits of resolution. A better understanding of the principals of the present invention can be had with reference to the derivation below. In general, the duty cycle can be expressed as the ratio of the pulse “on” time to the total period as given in equation (1).
Duty Cycle=total pulse on time/total period Eq. (1)

For a fixed bit modulator having n bits of resolution and a nominal period, Pₙ, the shortest duration pulse has a length in seconds of:

$$Unit Pulse Length ( s ) = U = \frac{{P}_{n}}{{2}^{n}} \qquad Eq . ( 2 )$$

In one embodiment, the total pulse on time in that state can be expressed as:

$$ON TIME STATE k = \frac{{N}_{k} {UP}_{T}}{{P}_{n}} \qquad Eq . ( 3 )$$

Where: Nₖ=number of unit pulse lengths specified in that state=output of modulator for state k; and
P_{T}=the additional timer period in seconds

The total pulse on time can be obtained by summing equation (3) for each state k=0 to k=K−1, where K equals the total number of states; e.g. K=2^{m}, where m=the numbered virtual bits of resolution added.

The total time period, T, in seconds, is given as:
T=P_{T}K Eq. (4)

The duty cycle of the pulse width modulation according to the present invention can therefore be expressed as:

$$Duty Cycle = \frac{{\sum }_{k = 0}^{k = K - 1} ( \frac{{N}_{k} {UP}_{T}}{{P}_{n}} )}{T} = \frac{{\sum }_{k = 0}^{k = K - 1} ( \frac{{N}_{k} {UP}_{T}}{{P}_{n}} )}{{P}_{T} K} = {\sum }_{k = 0}^{k - K - 1} \frac{{N}_{k} U}{{P}_{n} K} \qquad Eq . ( 5 )$$

For the smallest possible duty cycle, only one single unit pulse will be specified and will occur in only one of the k states. By setting Nₖ=1 (where 1 is the smallest non-zero integer), equation 5 can thus be reduced to express the highest resolution duty cycle as:

$$Minimum Duty Cycle = \frac{U}{{P}_{n} K} \qquad Eq . ( 6 )$$

Substituting Eq. (2) into Eq. (6) and reducing the equation yields:

$$Minimum Duty Cycle = \frac{1}{{2}^{n}} \cdot \frac{1}{K} \qquad Eq . ( 7 )$$

Thus, various embodiment permit additional bits of resolution to be added by adding states to the additional timer. For the example two bit processor of FIGs. 1A-1C and Table 1, additional virtual bits of resolution can be added as shown in Table II below.

TABLE II
Pulse Width Modulator Resolution as a Function of Number of Timer
States

| | No. of Bits of Virtual | Resulting Resolution For |
|---|---|---|
| No. of Timer States | Resolution Added | n = 2 Bit Modulator |
| 2 | 1 | 2³ |
| 4 | 2 | 2⁴ |
| 8 | 3 | 2⁵ |
| 16 | 4 | 2⁶ |

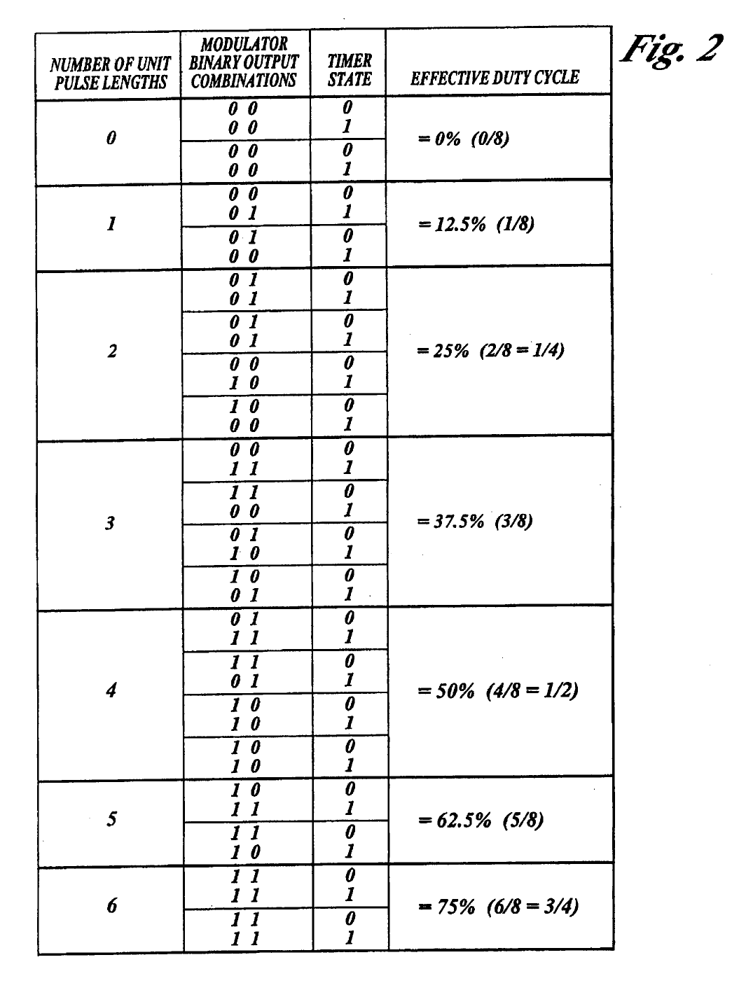

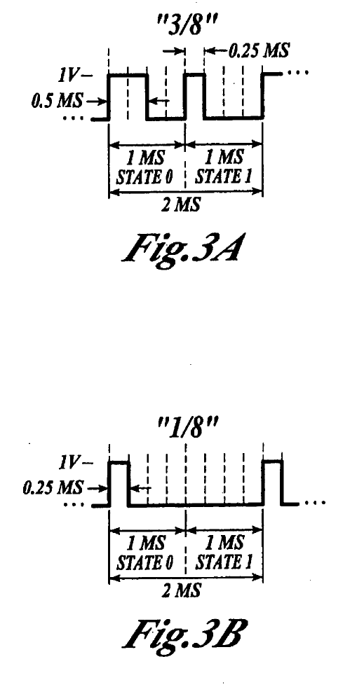

FIG. 2 and FIGS. 3A-3B illustrate how the resolution of the two bit pulse width modulator of FIGs. 1A-1C can be improved according to the present invention. The embodiment of FIG. 2, adds a single additional timer having the same period as the pulse width modulation period. In this example, that period equals ms and the total time period is therefore 2 ms. The timer has two states: 0 and 1 thereby providing 2³ bits of resolution. In timer state 0, the pulse width modulator output has a first value. In timer state 1, the modulator output has a second value for the duration of the timer state. The first value and the second value output by the pulse width modulator in each of the timer states can be equivalent if desired. The sum of the first and second values, however, equals the total number of unit pulse time intervals required to obtain the desired duty cycle.

FIG. 2 contains a truth table for creating the various duty cycles in 1/2³ increments. If a duty cycle of ⅜ is desired, the total number of unit pulse lengths occurring during the two timer states must equal 3. In the example truth table of FIG. 2, any one of four possible combinations of modulator output as a function of timer state may be implemented to obtain the desired three pulse units. For example, during timer state 0, the modulator output can be set to 00 and no pulse is output during the first 1 ms. During the second 1 ms period, the additional timer is in state 1 and the modulator output is binary 11, or decimal 3, and a pulse of three unit lengths are output during this time period. The total output during the two timer states is thus three pulse units yielding a duty cycle of ⅜. Optionally, a pulse of two pulse unit lengths, or 0.5 ms may be output in timer state 0 and one pulse of 0.025 ms may be output in timer state 1 to obtain the ⅜ duty cycle. FIG. 3A shows the corresponding waveform.

FIG. 3B shows a waveform for a ⅛ duty cycle constructed according to the example truth table of FIG. 2. In FIG. 3B, when the timer is in state 0, the pulse width modulator binary output is 01 and a single 0.25 ms pulse is output during the time period t=0 until t=1 ms. From the time period t=1 ms to t=2 ms the timer is in state 1 and no pulse is present during this interval. As shown in FIG. 2, the single pulse may optionally be set to occur in state 1, while no pulse is provided in state 0.

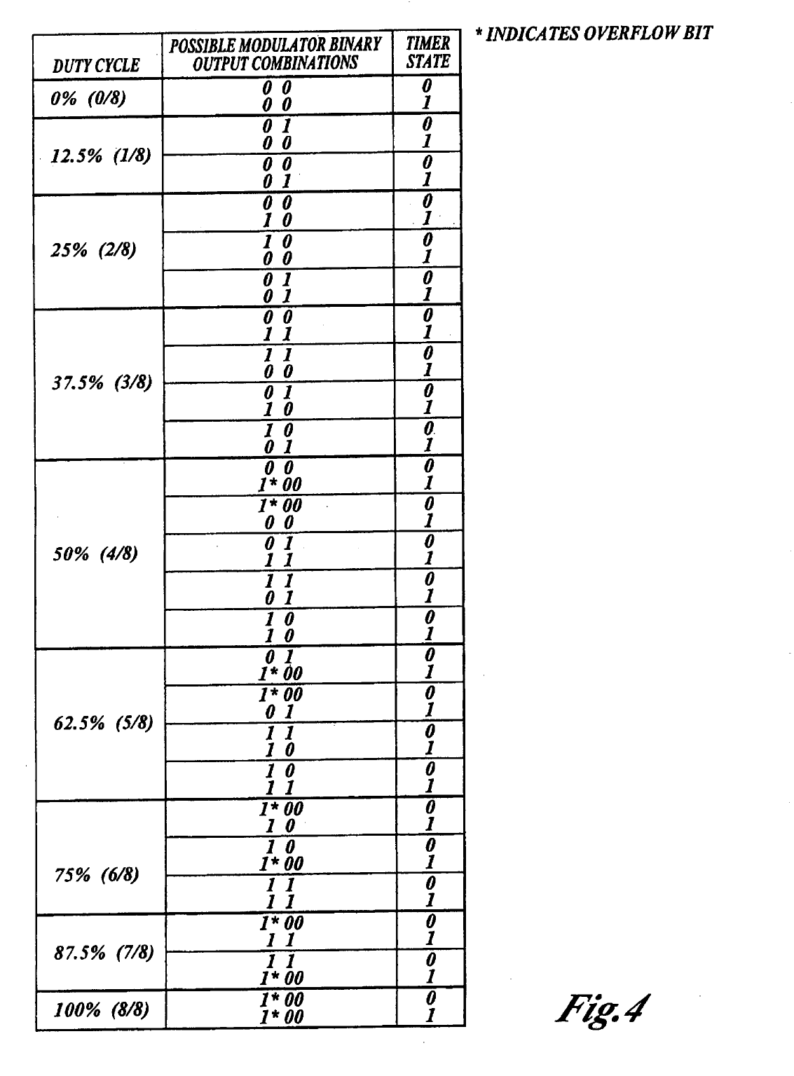

Some modulators allow for a 100% duty cycle through the use of an overflow bit. Thus, a bit modulator will have an overflow bit in the n+1 bit position, that when asserted, results in an output pulse having the length of the nominal modulator time period. Use of the overflow bit may be incorporated into the present invention. FIG. 4 illustrates how the example modulator of Table I can be used with an overflow bit to create a pulse width modulator having 3 bit resolution using an additional two state timer according to the present invention. As with the truth table of FIG. 2, various modulator output combinations are possible to obtain certain ones of the possible duty cycles.

As shown in each of the above examples, the total period of the pulse width modulator has been effectively increased from the 1 ms period of FIGs. 1A-1C to the 2 ms period of FIGS. 2 and 3A-B through the use of the additional timer. In the example of FIGs. 1A-1C, the update interval occurred every 1 ms, or 1000 Hz, whereas from the example of FIGS. 2 and 3A-B, the update interval is 2 ms, or 500 Hz. Thus, the additional resolution provided by the present invention impacts the update rate available. A lengthy update rate can cause perceptible flicker in the LCD display. However, so long as any required update rates can be maintained, additional “virtual bits” of resolution may be added according to the present invention.

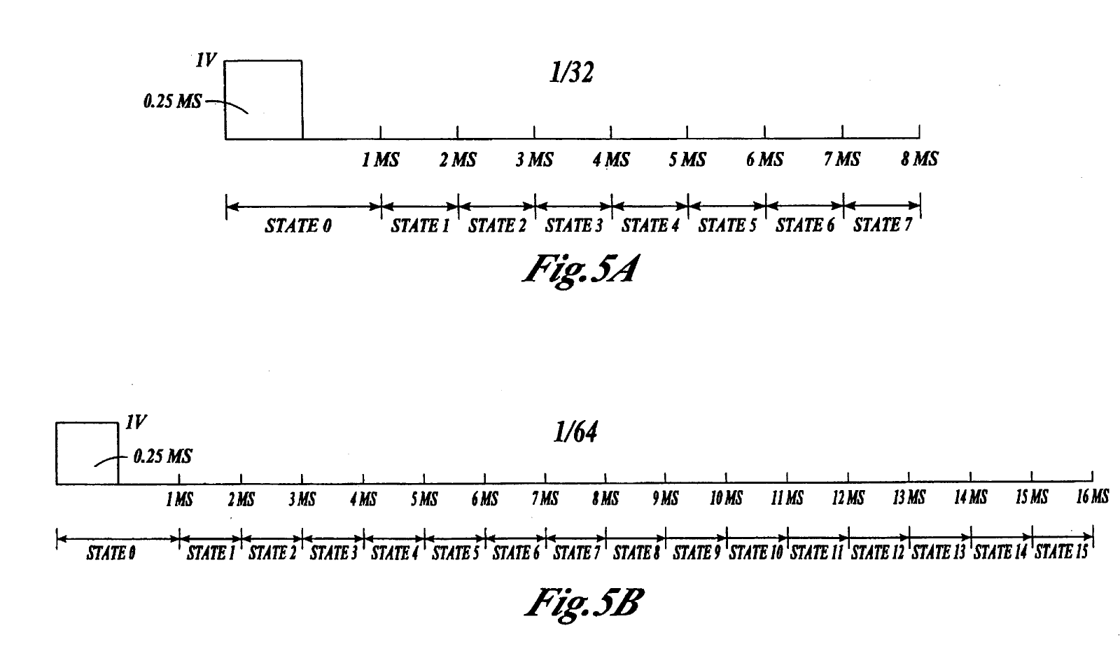

For example, suppose the example two bit modulator of Table I was required to have increased resolution according to the techniques of the present invention while maintaining an update rate of at least 100 Hz. A virtual five bit pulse width modulator with an update speed of 125 Hz could be created by adding additional timer states as shown in Table II. A total of 8 states are required, which for an additional timer period of 1 ms yields an 8 ms total period. The resulting minimum duty cycle is thus ½⁵, or 1/32. This modulation scheme is shown in FIG. 5A. However, increasing the virtual modulation to six bits equates to a minimum duty cycle of 1/2⁶ or 1/64. For the two bit modulator of Table I, and per Table II, 16 timer states are required for a total time period of 16 ms. The resulting waveform is as shown in FIG. 5B. The update rate is thus 62.5 Hz which does not meet the 100 Hz update requirements specified for the system.

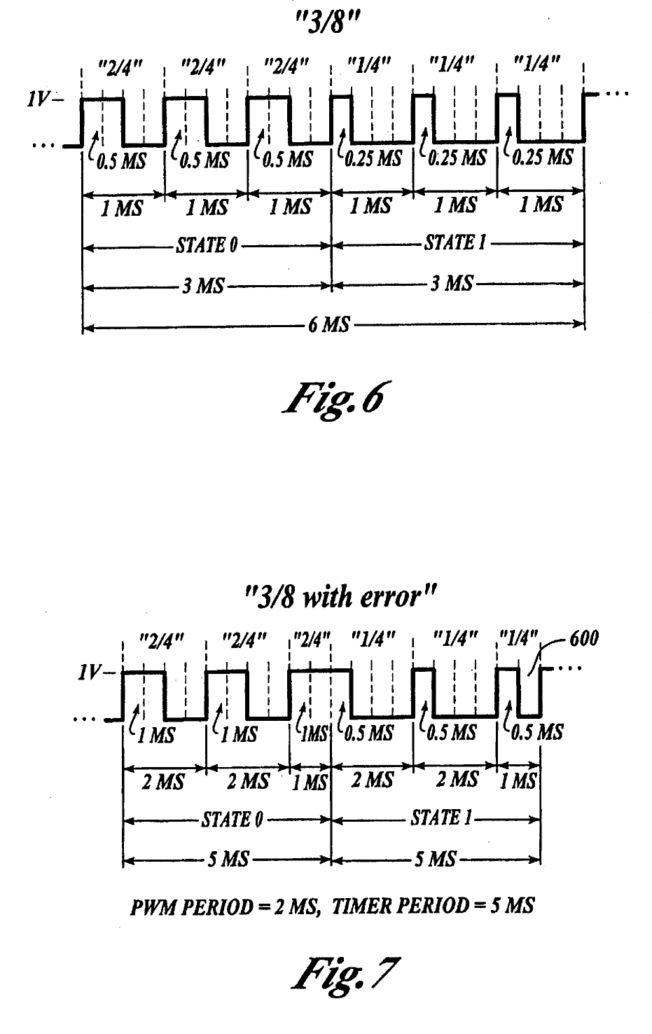

In the example of FIGS. 2, 3A-3B and 5A-5B, the additional timer has a period equal to the normal period of the pulse width modulator. Different time periods may be used with the additional timer of the present invention. Preferably, the additional timer has a period that is an integer multiple of the nominal period of the pulse width modulator period. FIG. 6 illustrates an implementation of the present invention using the example two bit pulse width modulator of Table I with a nominal period of 1 ms and an additional timer having a period of 3 ms. The example of FIG. 6 shows an effective duty cycle of ⅜ using this technique. As seen in FIG. 6, the output of the modulator is a first value, binary 10, during the initial 3 ms period when the additional timer is in state 0. During the second 3 ms time period, the additional timer is in state 1 and the modulator output is binary 01.

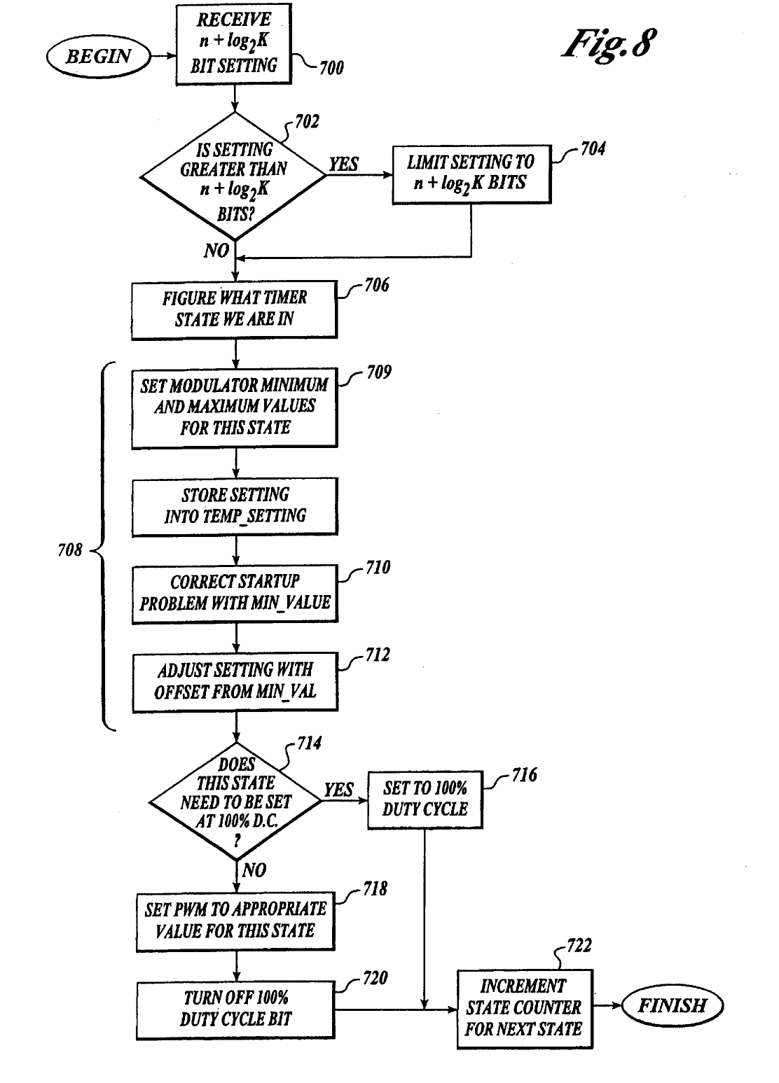

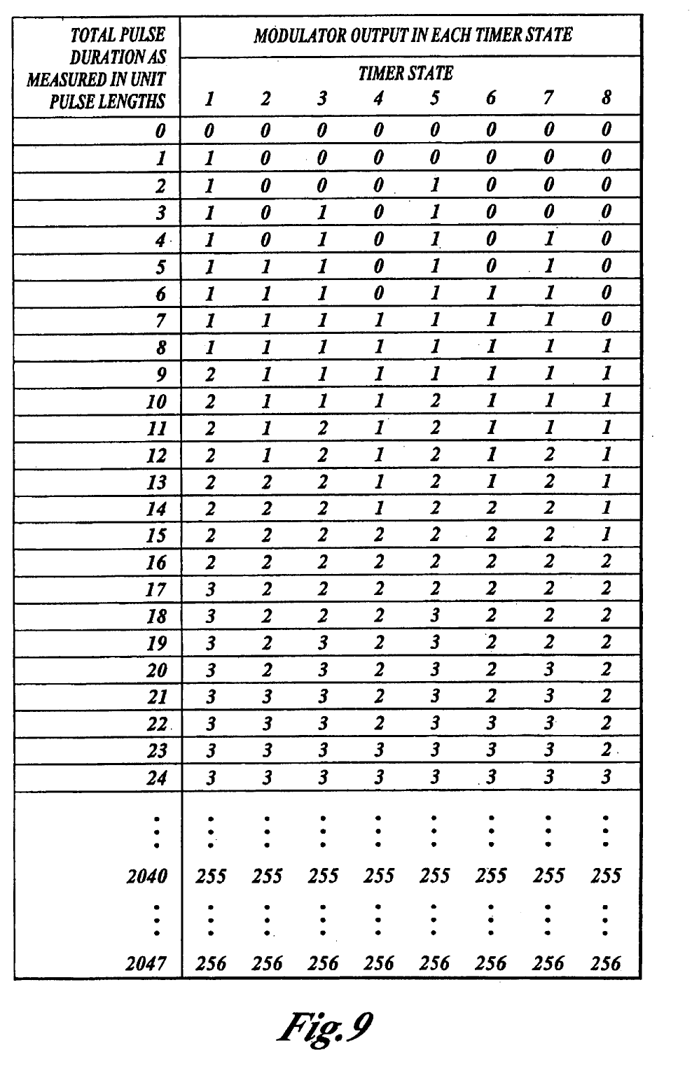

Constructing a pulse width modulator having an additional timer with a period not an integer multiple of the nominal period is possible, but may introduce nonlinearities in the modulator output. However, if the additional timer period is sufficiently larger than the period of the modulator output, these nonlinearities will be minimal. FIG. 7 diagrams such a modulation scheme for a pulse width modulator having a 2 ms nominal period and an additional timer period of 5 ms, to create a virtual 3 bit modulator. A three bit modulator can theoretically increment the duty cycle in increments of ⅛. In the diagram of FIG. 7, a ⅜ duty cycle is implemented, however, due to errors caused by the nonlinearities described above, the duty cycle is only approximately ⅜ and includes some error. Specifically during state 0, three 1 ms pulses occur. During state 1, three 0.5 ms pulse occur, but rest interval 600 shown in FIG. 7 is truncated in length and is less than the 1.5 ms rest interval associated with the remaining 0.5 ms pulses. The average duty cycle for the modulation scheme of FIG. 7 is thus:

$$\frac{1 ms + 1 ms + 1 ms + 0.5 ms + 0.5 ms + 0.5 ms}{10 ms} = 45 \%$$

A 45% duty cycle is slightly larger than the ⅜, or 37.5% duty cycle desired. The resulting error in the duty cycle is therefore:

$$\frac{0.45 - 0.375}{0.375} = 20 \% relative error$$

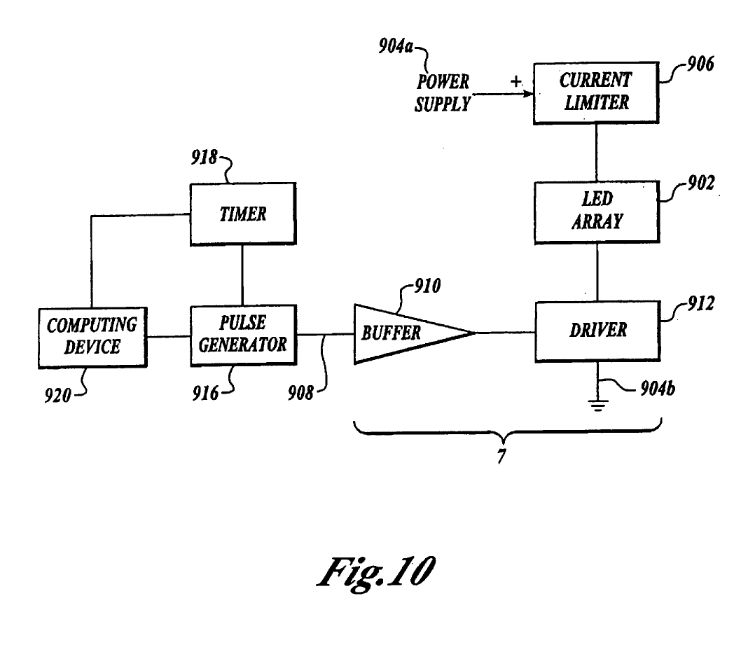

FIG. 8 contains a flow chart of a process useful for implementing the improved pulse width modulation of the present invention. In the flow chart of FIG. 8, the desired duty cycle is specified in step 700 as a word having n=log₂ K significant bits. In steps 702 and 704, the word is truncated to the maximum number permitted if the word received is in excess of this value. In step 706, the current state of the additional timer is determined. The various steps shown grouped together by braces 708 of FIG. 8 assign a modulator output value to the given timer state. In one embodiment of the invention, the modulator outputs associated with each of the various states are within one of the other. Other combinations are possible, however, in one embodiment of the invention, steps 710 and 712 are used to ensure that a valid modulator output is specified at start up; and in conjunction with step 709, are used to validate that the modulator output specified is within the maximum and minimum values expected for this state. Step 74 checks if a 100% duty cycle is needed for this state and if so, step 716 asserts the modulator overflow bit. Otherwise, the desired modulator output value is set in step 718 and the overflow bit deasserted in step 720. The modulator output for the current state is now established. Step 722 increments to the next state and the modulator output for that state is set by repeating the process flow of FIG. 8.

FIG. 9 shows a table of modulator output values used to create a virtual 11 bit modulator from an n=8 bit modulator using the process of FIG. 8. In FIG. 9, a modulator output is associated with each one of eight additional timer states according to the duty cycle desired.

The present invention may be implemented as firmware, in executable code, as software stored in a memory device or as a microelectronic circuit as will be readily apparent to those of ordinary skill in the art. In addition, the present invention, may be used to control the brightness of existing LCD or other LED backlit displays with greater precision without hardware redesign of the controlling pulse modulator.

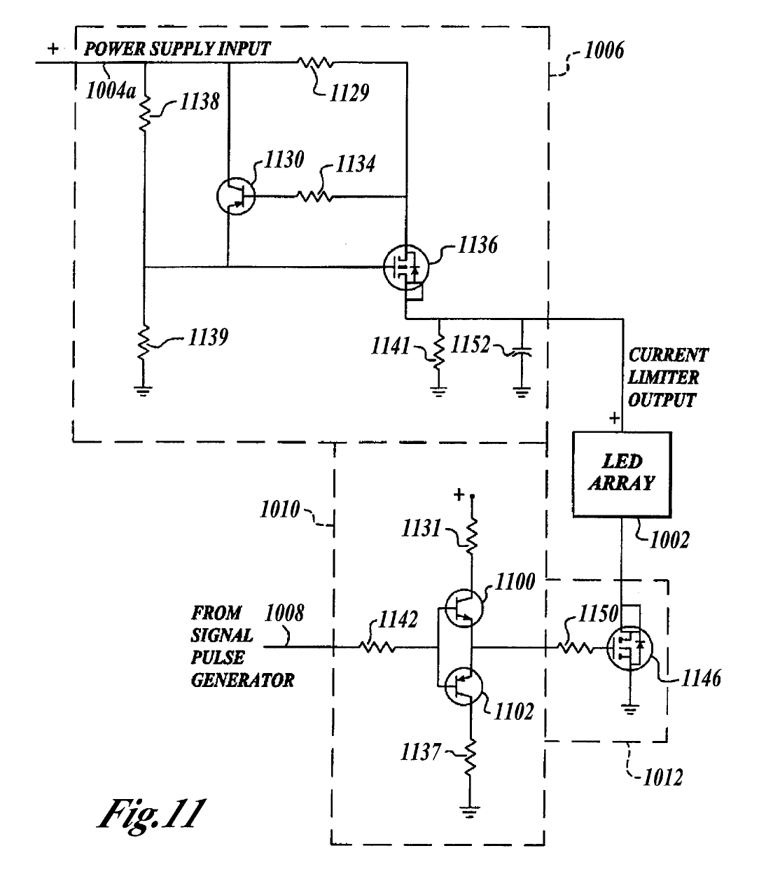

FIG. 10 is a top level diagram of a controller useful for controlling an LED array and in particular useful as a dimming controller for a LED backlit display. In the block diagram of FIG. 10, an LED array 1002 receives power from a power supply having positive and negative terminals 1004a and 1004b respectively. Although the diagram of FIG. 10 shows the negative pole 1004b of the power supply to be at ground, other values may be used so long as a potential difference exists between the two poles. The block diagram of FIG. 10 additionally includes a current limiter 1006 disposed between LED array 1002 and the positive pole 1004a of the power supply. As will be explained in greater detail below, current limiter 1006 serves to prevent the current draw of LED array 1002 from exceeding a predetermined threshold value. Current limiter 906 prevents overheating of the LEDs comprising the display by limiting the amount of current flowing through the entire array or, optionally, through the individual array strings. Current limiter 1006 may comprise a plurality of resistors arranged in series with each of the individual array strings. Optionally, current limiter 1006 may be as described in copending patent application Ser. No. 09/834,277, entitled: “Apparatus and Method for Controlling LED Arrays,”, now U.S. Pat. No. 6,680,834, filed the same day herewith and incorporated by reference.

A control circuit 1007 regulates the brightness level of array 1002. Control circuit 1007 receives a control signal 1008 in which is encoded the desired brightness level. Control signal 1008 may comprise a pulse width modulated signal from a pulse generator referred to as modulator 1016 useful for regulating display brightness by regulating the average voltage supplied to the LED array 1002 in a given time interval. A Motorola 68HC16Z1 processor is an example of circuits known to those of skill in the art useful for generating control signal 1008. In one embodiment, the pulse width modulation resolution may be additionally enhanced in the manner described above by providing additional timer states. Other control signals known to those of skill in the art may also be used.

Control signal 1008 is passed through a buffer 1010. In one embodiment, buffer 1010 in one embodiment comprises a standard push/pull buffer known to those of skill in the art. Buffer 1010 is designed to have a response time faster than the shortest duration pulse contained in control signal 1008.

The buffered control signal output by buffer 1010 is input to a driver 1012. Driver 1012 comprises a “low side” driver that regulates the power level, and hence brightness, of array 1002 by switching on and off in response to control signal 1008. When the switching circuit of driver 1012 is closed, a potential difference exists between terminals 1004a and 1004b and current flows through array 1002. According to one embodiment of the invention, the switching mechanism of driver 1012 comprises a field effect transistor (FET).

In one embodiment, Also according to the present invention, n bit modulator 916 is coupled to an additional timer 918 that can be used to generate K=2^{m} states. Modulator 916 is additionally coupled to a computing device 920 which may comprise a cpu, programmable logic device or other general purpose processor, analog or digital logic circuit. Computing device 920 may additionally include memory for storing code such as, for example, that described by FIG. 8 useful for assigning a modulator output to each of the K timer states of timer 918, wherein said code is executed by computing device 920. Computing device 920 may optionally include timer 918 or be able to assert interrupts using an internal clock to thereby function as timer 918.

FIG. 11 contains a circuit diagram useful for explaining the construction and operation of the block elements of FIG. 10 in greater detail. The invention is not limited to the specific component specifications and part numbers provided in the drawing, and the parts may be sized in accordance with the load and performance requirements of the array. FIG. 11 is a representative embodiment. As will be readily apparent to those of skill in the art, equivalent circuits may be designed to perform in the manner taught by the present invention.

As shown in the embodiment of FIG. 11, buffer 1010 comprises two transistors 1100 and 1102 arranged in push/pull configuration and coupled to resistances 1131 and 1137 respectively. Control signal 1008 is supplied through resistor 1142 and to transistors 1100 and 1102. Buffer 1010 operates to increase the magnitude of the current supplied by control signal 1008 to rapidly drive the gate of switching transistor 1146 of driver 1012. The drive signal received through resistor 1150 at the gate of transistor 1146 causes transistor 1146 to turn on or off in correspondence with control pulse 1008. Preferably buffer 1010 is designed to supply sufficient current to transistor 146 such that transistor 1146 can turn on and off within the time frame of the narrowest control pulse 1008. If transistor 1146 did not turn on or of with a response time corresponding the shortest duration pulse, nonlinearities would be introduced into the brightness control of array 1002.

When a positive control pulse is provided on line 1008, transistor 1146 switches to a state in which current is drawn through array 1002. The brightness level of array 1002 is governed by the average power supplied to array 1002. Increasing the number or duration of the control pulse signals increases the amount of time transistor 1146 operates to draw power through array 1002 and increases the brightness of the display.

Current limiter 1006 operates to prevent an overheating problem from developing due to excessive current being drawn by the LEDs comprising the array. A known characteristic of LED devices is that the LEDs become warm during use. As the LED heats up, the LED forward voltage drops and the LED attempts to draw more current. This characteristic can result in a condition known as “current runaway.” in which the LED heats up further, further reducing its forward voltage drop and the array thus attempts to draw an ever increasing amount of current. Such a condition strains the power supply and the operating integrity of other loads on the circuit. In extreme circumstances, the current runaway condition can result in the array catching fire.

The current runaway problem may also be caused by manufacturing irregularities and normal statistical variations in the characteristics of the individual LED devices. Specifically, one LED or one particular manufacturing lot of LEDs may have a slightly different forward voltage drop than another. When arranged in an array, those LEDs having a lower forward voltage drop than the other LEDs in the array will attempt to draw more current. These LEDs will heat up at a faster rate than the remaining devices, placing a still greater and disproportionate demand for current on the power supply system. Without design safeguards, a current runaway condition will again result.

In the embodiment of FIG. 11 current limiter 1006 is coupled to the positive side of power supply line 1004a. When driver 1012 activates array 1002, a current draw occurs and current flows through limiter 1006. A voltage drop occurs on resistor 1129. This voltage drop functions as a current sense element. The voltage difference is supplied to the base of a transistor 1130 through resistor 1134 and provides transistor 1130 with just enough current to turn transistor 1130 slightly on. The current through resistor 1129 is also supplied to transistor 1136. Transistor 1136 is designed to be on whenever a predetermined threshold gate voltage is present due to current flow through resistors 1138 and 1139, relative to the source voltage of transistor 1136. As current draw from array 1002 increases, the voltage drop across resistor 1129 also increases. The increased voltage drop causes transistor 1130 to turn on more fully. Transistor 1130 will continue to turn on in proportion to the increased current draw. When transistor 1130 becomes more fully turned on, the voltage difference on the collector and emitter of transistor 1130 becomes less. As a result, the gate to source voltage on transistor 1136 becomes less causing transistor 1136 to begin to shut off. This action limits the current flowing to array 1002. Circuit 1006 therefore acts as a closed loop system to limit the current supplied to array 1002 and prevent current runaway. Current limiter 1006 is preferably designed to limit current with a response time corresponding to the shortest duration pulse of control signal 1008. Such a design ensures linearity of light output in proportion to the duration of the brightness control signal. Resistor 1141 is useful for testing of circuit 1006. Capacitor 1152 is useful for limiting electromagnetic interference caused by operation of the display circuit. Limiting electromagnetic interference can be desirable in certain applications such as aboard aircraft.

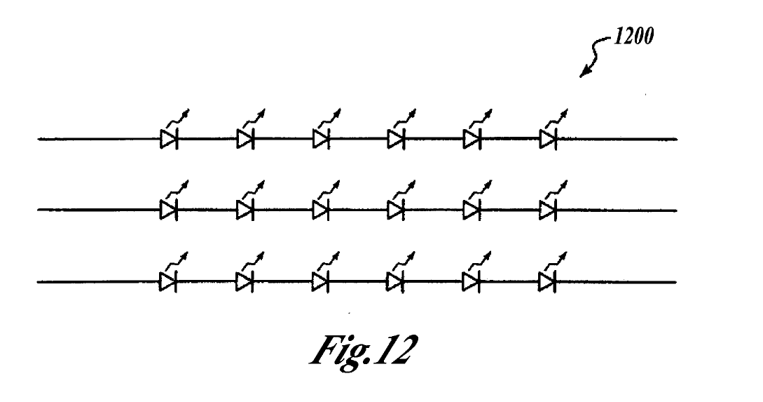

The current limiter places an overall current limit on LED array 1002. This feature of the present invention permits the LED array to be constructed in the manner shown in FIG. 12. By limiting the overall current provided to array 1002, there no longer exists a need for resistors to be coupled in series with each LED string. The power dissipation and heat generation disadvantages of the prior art design are thus avoided by the present invention. The power supply may therefore be sized within a few volts of the nominal power load expected from the array. For example, in an application designed using one embodiment of the invention, the array nominally requires a 21.5 volt power supply. A 23 volt power supply was found to be adequate for use with the design. The cost of the power supply used with the array is thereby reduced as well as the cost of associated circuitry.

The current limit device may provide additional advantages in different embodiments. One embodiment minimizes the effects of unwanted power supply voltage fluctuations and non-uniformity of supply voltage level among individually manufactured units. Similar to the LED variances described above, power supplies manufactured in different lots or by different manufacturers may have slightly different output tolerances. The different tolerances may cause the supply voltage to vary between parts. Supply voltage may also vary due to other loads placed on the power supply. These other circuits connected to the power supply may cause the supply output to vary. The current limiting device of the present invention minimizes the effects of such fluctuations by maintaining an upper limit on the current supplied to the array as a whole.

The invention has now been described with reference to the embodiments. Variations and modifications will be readily apparent to those of ordinary skill in the art. For these reasons, the invention is to be interpreted in view of the claims.

What is claimed is:

1. A device for use in controlling one or more LEDs (light emitting diodes), comprising:
a modulator having at least 11 bits of pulse width modulation resolution;
a buffer adapted to receive pulses from the modulator; and
a buffer output that provides pulses from the buffer adapted for connection to a driver.

2. The device of claim 1 wherein the driver comprises a switch adapted to turn on and off within a time frame corresponding to the pulses provided by the modulator through the buffer.

3. The device of claim 1 wherein the modulator has an update rate of at least approximately 100 Hz.

4. The device of claim 1 and further comprising a driver coupled to the buffer output and coupled to an LED backlight.

5. The device of claim 4 wherein the LED backlight is coupled to illuminate a liquid crystal display.

6. The device of claim 1 adapted to prevent a current draw of the one or more LEDs from exceeding a threshold value.

7. The device of claim 6 wherein the adapted device comprises current sensing feedback circuitry to prevent a current draw of the one or more LEDs from exceeding a threshold value.

8. The device of claim 1 wherein the modulator comprises one or more of: firmware, hardware, and software.

9. A device comprising:
one or more LEDs (light emitting diodes);
a modulator having at least 11 bits of pulse width modulation resolution while maintaining an update rate fast enough to preclude perceptible flicker;
a buffer adapted to receive pulses from the modulator; and
a driver that receives pulses from the buffer and provides them to the one or more LEDs.

10. A device for controlling one or more LEDs (light emitting diodes), the device comprising:
a modulator having at least 11 bits of pulse width modulation resolution while maintaining an update rate fast enough to preclude perceptible flicker;
a buffer coupled to the modulator and adapted to receive pulses from the modulator; and
a driver that receives pulses from the buffer and having an output for coupling to the one or more LEDs.

11. The device of claim 10 wherein the driver is a switch adapted to turn on and off within a time frame corresponding to the pulses provided by the modulator through the buffer.

12. The device of claim 10 adapted to prevent a current draw of the one or more LEDs from exceeding a threshold value.

13. The device of claim 10 wherein the buffer has a response time at least as fast as a shortest duration pulse from the modulator.

15. A method for controlling one or more LEDs (light emitting diodes), the method comprising: receiving a control signal having at least 11 bits of pulse width modulation resolution and an update rate that precludes flicker over a wide dimming range;
buffering the control signal using a buffer that operates with a response time at least as fast as the shortest duration pulse of said control signal to obtain a buffered control signal; and
making the buffered control signal available to a driver to drive the one or more LEDs according to said buffered control signal.

16. The method of claim 15 and further comprising limiting an amount of current supplied to the entire array while maintaining continued operation of the one or more LEDs.

17. The method of claim 15 wherein the control signal is provided by an 8 bit modulator with 8 additional timer states to form a virtual 11 bit modulator.

18. A method for controlling the brightness of a LED device, the method comprising:
receiving a pulse width modulated control signal representative of a desired LED device brightness and having at least 11 bit resolution and an update rate that prevents flicker;
supplying power to the LED device in accordance with said pulse width modulated control signal; and
preventing a magnitude of current drawn by the LED device from exceeding a predetermined threshold value while maintaining continued operation of the LED device.

19. The method of claim 18 wherein the update rate is at least approximately 100 Hz.

20. A device for use in controlling one or more LEDs (light emitting diodes), comprising:
a modulator having a dimming resolution of at least 2¹¹;
a buffer adapted to buffer pulses from the modulator; and
a buffer output adapted to provide pulses from the modulator to a driver.

21. The device of claim 20 and further comprising a current limiter.

22. The device of claim 21 wherein the current limiter comprises current sensing feedback circuitry to prevent a current draw of the one or more LEDs from exceeding a threshold value.
